(19) United States
(12) Patent Application Publication
(10) Pub. No.: US 2012/0326429 A1
(43) Pub. Date: Dec. 27, 2012

(54) FORM WITH INTEGRATED FOLDING CARD AND METHOD FOR PRODUCING A FOLDING CARD

(76) Inventors: Jules Fischer, Oberwil-Lieli (CH); Walter Stutz, Wohlen (CH)

(21) Appl. No.: 12/998,249

(22) PCT Filed: Dec. 22, 2010
(86) PCT No.: PCT/CH10/00328

§ 371 Date: Sep. 10, 2012

(51) Int. Cl. B42D 15/04; B42D 15/10; B32B 38/00

(52) U.S. Cl. 283/75; 156/222; 283/106; 283/109

(57) ABSTRACT

A form with an integrated folding card comprising a flat substrate and a multi-layer material adhesively bonded to at least one part-region of the rear of the substrate with a first adhesive layer. The multi-layer material comprises, as viewed from the substrate, the first adhesive layer, a first dividing layer, a carrier layer, a second dividing layer, a second adhesive layer, and an at least partially transparent top layer. The folding card comprises two core parts and two covering parts. The form, in the region of the multi-layer material, has a first punch made from the front which forms the two core parts. The form, in the region of the multi-layer material, has a second punch made from the rear as far as the carrier layer at the most which forms the two covering parts. The two core parts are arranged in a connected manner adjacently to each other in the same plane in the form, for the core parts and the covering parts to be coextensive, and for the first punch to be made as far as the carrier layer at the most. A method for producing a personalised folding card which is plasticised on both sides is also provided.

### CROSS-REFERENCE TO RELATED APPLICATIONS

This application is a National Stage application of International Application No. PCT/CH2010/000328, filed on Dec. 22, 2010, which claims priority of Swiss patent application number 42/10, filed on Jan. 14, 2010, both of which are incorporated herein by reference in their entireties.

### BACKGROUND OF THE INVENTION

1. Field of the Invention

The present invention relates to a form with an integrated folding card, comprising a flat substrate and a multi-layer material which is adhesively bonded to at least one subregion of the rear of the substrate with a first adhesive layer, wherein the multi-layer material comprises, viewed from the substrate, the first adhesive layer, a first dividing layer, a carrier layer, a second dividing layer, a second adhesive layer and an at least partially transparent top layer, wherein the folding card comprises two core parts and two covering parts, wherein in the region of the multi-layer material the form has a first punch which is made from the front and forms the two core parts, and wherein in the region of the multi-layer material the form has a second punch which is made from the rear as far as the carrier layer at the most and forms the two covering parts.

The invention also relates to a method for producing a personalised folding card which is plasticised on both sides, consisting of two core parts and two covering parts, using at least one form in which the two core parts and the two covering parts can each be removed and are integrated in a connected manner along a fold line.

2. Description of the Prior Art

WO 2004/018222 describes a form with a detachable, integrated folding card consisting of two connected parts, wherein the form consisting of a multi-layer material comprises a first paper layer, a first adhesive layer, a foil layer, a second adhesive layer, a dividing layer and a second paper layer. A punch from the side of the first paper layer as far as the dividing layer produces the two connected parts of the folding card. When detaching the parts of the folding card from the form, the layers are separated between the second adhesive layer and the dividing layer. The two parts are folded together to form the finished folding card. Such a folding card can be personalised by printing the form on both sides. The personalisation is however unprotected on the surface of the folding card and is therefore not very long-lasting. Also, the whole form consists of multi-layer material, which has a negative effect on the material costs.

Like WO 2004/018222 above, WO 2008/128362 describes a form similar in structure with an integrated folding card, in this case only a limited region of the form having a multi-layer material. The multi-layer material is applied to one or both sides of the form paper. The folding card can likewise be personalised on both sides, the personalisation also being situated in an unprotected manner on the surface of the folding card.

WO 2007/115420 describes a form with an integrated folding card, it being possible to personalise and then plasticise the folding card on both sides. In this case a multi-layer material consisting of a first adhesive layer, a first dividing layer, a carrier layer, a second dividing layer, a second adhesive layer and a foil layer is applied to the rear of the form paper. Two individual, unconnected core parts are punched out by means of a first punch from the front through the carrier layer as far as the second dividing layer. These two core parts are situated inside the finished folding card. A second punch from the rear through the foil layer as far as the second dividing layer produces two connected covering parts, which are situated on the outside in the finished folding card, these covering parts being larger in area than the core parts. The personalisation on the finished folding card is thus protected by plasticisation, but a transparent border running around the core parts is produced, which is not aesthetically appealing. The form has the further disadvantage that it is complicated to use. After personalisation, the two covering parts are removed individually from the form, rotated and inserted back into the form with the personalisation facing down. The core parts together with the covering parts are then pressed to the rear out of the form, the carrier layer and the two dividing layers are pulled off the core parts, and the card is folded up. It can easily happen, in particular when removing, rotating and reinserting the core parts, that the core parts are inserted the wrong way round and the personalisation is thus not the right way round on the two sides of the folding card.

WO 2008/043193 describes a form with an integrated folding card. The folding card can be personalised on both sides, the personalisation being protected by plasticisation in the finished folding card. The form consists of a flat substrate which is provided with two different multi-layer materials in two non-overlapping regions. The two regions each have a stamp which is made from the front, as a result of which two connected core parts are punched out in one region and two connected covering parts are punched out in the other region. The core parts and the covering parts are coextensive, a transparent border running round the core parts being avoided. The form also has a fold line in the region between the two multi-layer materials, which fold line is produced by a perforation punch. The finished folding card can then be produced by repeated removal of different layers and repeated folding to and fro. The form however has the disadvantage that during its production the punches must be made exactly in register and with the same punching plate so that the individual parts match each other exactly when folded up when the form is used. The production of the form is thus complex. The form is also rather complicated to handle.

The forms described in WO 2007/115420 and WO 2008/043193 could in particular not become established, which is presumably connected with their production complexity, material costs and/or their lack of completely simple handling by the end user when removing and creating the folding card.

### SUMMARY OF THE PRESENT INVENTION

The object of the invention is to specify a form with an integrated folding card of the type mentioned in the introduction, which is simple and inexpensive to produce and simple to handle. It should be possible to personalise the folding card over its entire area on both sides. The finished folding card should furthermore be plasticised over its entire area on both sides and be aesthetically appealing. A method should also be specified which is easy to carry out and in which a finished folding card can be produced using a form with in each case two integrated, removable core and covering parts.

This is achieved according to the invention in a form with an integrated folding card by the features of claim 1. The form according to the invention is thus characterised in that the two core parts are arranged adjacently to each other in a connected manner in the same plane in the form, that the core parts and the covering parts are coextensive, and that the first punch is made as far as the carrier layer at the most.

The form according to the invention allows the production of folding cards which are personalised and plasticised over their entire area on both sides. Handling is greatly simplified compared to the form of WO 2007/115420. The finished folding card is also aesthetically more appealing because the adhesion of coextensive core and covering parts avoids the transparent border typical of WO 2007/115420. The coextensive core and covering parts can lie one above the other in the form due to the two punches made as far as the carrier layer at the most, as a result of which the amount of multi-layer material can be minimised.

Compared to the form of WO 2008/043193, which needs two applications of multi-layer materials and a complex punching process, the production processes of the form according to the invention are greatly simplified and material is saved. The form according to the invention needs only one multi-layer material on the rear of the flat substrate. Also, the punches for the core parts and the punches for the covering parts do not have to be in register. The form is also simpler to handle.

Advantageous and therefore preferred configurations and developments of the invention are outlined in the dependent claims.

The subject matter of the invention is also formed by a method for producing a folding card using a form in which two core parts and two covering parts are integrated such that they can be removed and are connected along a fold line. The finished folding card consists of two core parts and two covering parts. The two core parts comprising a substrate and a first adhesive layer are adhesively bonded to each other in a coextensive manner with the first adhesive layer, and at least one of the two outwardly facing surfaces of the substrate is personalised. The two covering parts comprising a top layer and a second adhesive layer are adhesively bonded to the outwardly facing surfaces of the two core parts in a coextensive manner with the second adhesive layer. The finished folding card can have a personalisation on both sides and is plasticised on both sides by the covering parts. If required, a subsequent personalisation is possible by providing the top layer with a writeable layer. Conversely, the top layer can be provided with a silicone layer which prevents subsequent writing on the top layer.

The method for production is characterised by the following steps:

a) Personalisation of at least one surface of the substrate of the two core parts in the form containing the core parts. Such a personalisation can for example be carried out with a laser or ink jet printer.
b) Removal of the two core parts from the form containing the core parts and folding up the two core parts along the fold line and adhesively bonding the two core parts to each other by means of the first adhesive layers.
c) Detachment of a first covering part of the two covering parts from the form containing the covering parts in such a manner that the second covering part connected to the first covering part remains at least partially connected to the form. This produces a depression in the form as a fitting aid which makes it easier to correctly align the core parts which are adhesively bonded to each other.
d) Insertion of the core parts which are adhesively bonded to each other into the depression produced by the detachment of the first covering part.
e) Adhesively bonding the first, detached covering part onto the upper of the two core parts in the depression in order to plasticise the outer surface of the core part.
f) Removal of the core parts plasticised by the first covering part on one side in this manner from the depression together with the second covering part from the form containing the two covering parts.
g) Adhesively bonding the second covering part onto the previously lower of the two core parts in the depression by folding up the two covering parts along their fold lines in order to plasticise the outer surface of the core part.

This method for producing a folding card can be carried out using the above-described form, steps a) and b) being carried out on the front of the form and steps c) to g) being carried out on the rear of the form.

### BRIEF DESCRIPTION OF THE DRAWINGS

The invention is explained in more detail below using exemplary embodiments in connection with the drawing. In the figures:

FIG. 1 shows a form with an integrated folding card according to the invention under a) in a plan view of a portion of its front, under b) in section (I-I) and under c) the portion of its rear; and

FIG. 2 shows a method for producing a folding card using the form of FIG. 1 in section (I-I) under a)-g) in different phases.

### DETAILED DESCRIPTION OF THE PRESENT INVENTION

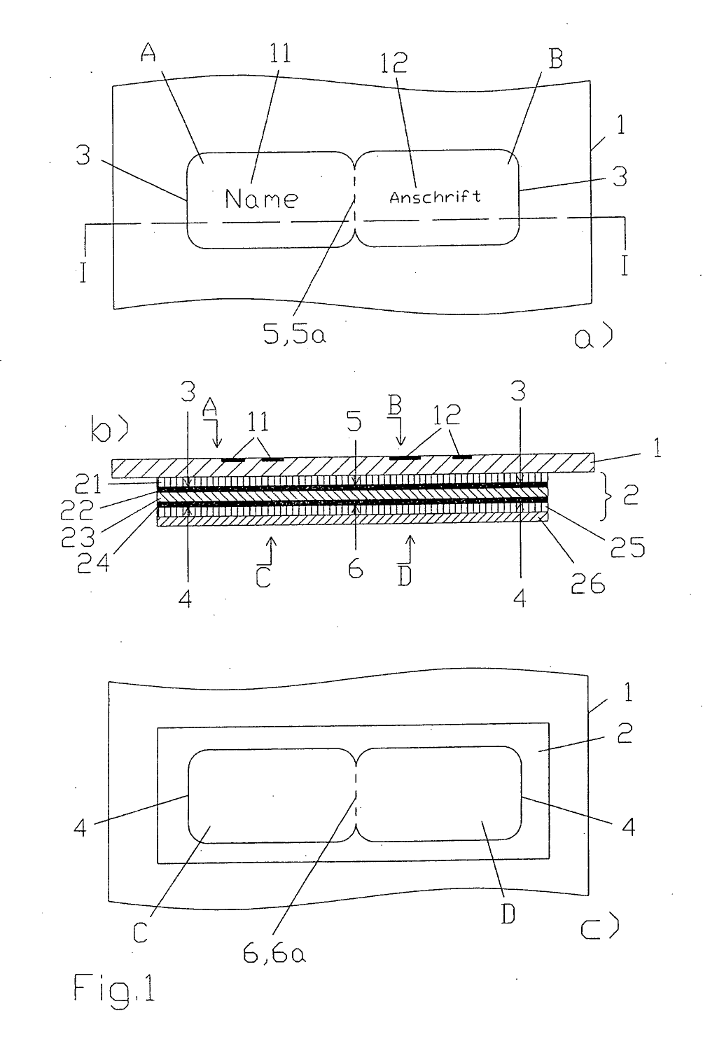

FIG. 1a) shows a portion of a form with an integrated folding card in a plan view of the front, where 1 denotes a flat substrate in the form of a rectangular sheet, for example in A4 format, arranged upright. The material of the substrate can be a paper layer with a thickness of 70 to 250 μm, preferably 100 to 160 μm. The material of the substrate can also be a printable foil layer, which is preferably opaque. Two core parts A, B, which are arranged adjacently to each other in the same plane, are punched out by a first punch 3 made in the front of the form. The two core parts A, B are coextensive and are connected along a fold line 5a. A first perforation punch 5 along the fold line 5a makes it easier to fold up the two core parts A, B when producing the finished folding card. The surfaces of the two core parts A, B left free on the front of the form can be printed for example with a laser or ink jet printer, which is indicated by the personalisation 11, 12. Such a personalisation can be for example name and address. Other personalisations such as writing such as a signature, an attached photo or the like are also possible.

The form could also be provided with a transponder, which can be for example an RFID label which can be detected contactlessly. Such a transponder can be adhesively bonded onto the front of the flat substrate 1 in the region of the core parts A, B or adhesively bonded between the flat substrate and the multi-layer material 2, in the second case the transponder coming to lie between the core parts A, B in the finished folding card and thus not being visible from the outside as long as the core parts are opaque.

FIG. 1c) shows the portion of FIG. 1a) in a plan view of the rear of the form. A multi-layer material 2 is adhesively bonded to the rear of the flat substrate 1. The multi-layer material 2 covers only a part-region of the substrate 1. This means that expensive multi-layer material 2 can be saved.

Two covering parts C, D, which are arranged adjacently to each other in the same plane, are punched out by a second punch 4 made in the rear of the form. The two covering parts C, D are coextensive and are connected along a fold line 6a. A second perforation punch 6 along the fold line 6a makes it easier to fold up the two core parts C, D when producing the finished folding card.

Instead of the perforation punches 5, 6, continuous stamps which extend only partially into the substrate 1 or into the top layer 26 can be present.

FIG. 1b) shows the form in section along section line I-I in FIG. 1a). As already mentioned, the flat substrate 1 can be printed on the front in the regions of the core parts A, B, which is shown by the personalisations 11, 12. The multi-layer material 2 is adhesively bonded to the rear of the substrate 1 by means of a first adhesive layer 21. The multi-layer material 2 comprises, in the following order as viewed from the substrate: the first adhesive layer 21, a first dividing layer 22, a carrier layer 23, a second dividing layer 24, a second adhesive layer 25 and a top layer 26.

The first and second adhesive layer 21, 25 is preferably a pressure-sensitive adhesive, for example an aqueous polyacrylate or a hot melt adhesive.

The first and second dividing layers 22, 24 are for example a silicone coating which is applied to both sides of the carrier layer 23. The carrier layer 23 is a foil layer or a paper layer with a thickness of 23 to 60 μm. With a foil layer as the carrier layer 23, this is preferably 23 to 36 μm thick. With a paper layer as the carrier layer, this is preferably 50 to 60 μm thick.

The top layer 26 is preferably a highly transparent polyester foil with a thickness between 23 and 200 μm, preferably 100 μm. The top layer 26 could be provided with a hologram. The top layer can also be provided with a writeable layer so that the finished folding card can be personalised again later, for example with a signature of the user. Conversely, the top layer can also have a silicone layer in order to prevent subsequent personalisation of the finished folding card.

The two core parts A, B are punched out by the first punch 3 which is made from the front in such a manner that they are connected along the fold line 5a as shown in FIG. 1a). The first punch 3 goes through the flat substrate 1 as far as into the first adhesive layer 21 or dividing layer 22 and no further than the carrier layer 23, so that the carrier layer 23 is not penetrated. The carrier layer can however be slightly stamped. The first perforation punch 5 extends, like the first punch 3, as far as the carrier layer 23. The core parts A, B can be removed from the form by detaching their first adhesive layer 21 from the first dividing layer 22.

The two covering parts C, D, which are situated on the rear of the form, are punched out by the second punch 4 made from the rear in such a manner that the two covering parts C, D are connected along the fold line 6a, as shown in FIG. 1c). The second punch 4 goes through the top layer 26 as far as into the second adhesive layer 25 or dividing layer 24 and no further than the carrier layer 23, so that the carrier layer 23 is not penetrated. The second perforation punch 6 extends, like the second punch 4, as far as the carrier layer 23. The core parts C, D can be removed from the form by detaching their second adhesive layer 25 from the second dividing layer 24.

The first and second punches 3, 4 are made all the way round without leaving punching webs. As the carrier layer 23 is not penetrated by the first and second punches 3, 4, they can lie one on top of the other. This results in further material savings for the multi-layer material 2.

A transparent varnish layer can also be present between the top layer 26 and the second adhesive layer 25, which varnish layer has lower cohesion than the adhesion to the top layer 26 and to the second adhesive layer 25. A structured, transparent separating coating, for example in the form of a VOID label, is arranged between the transparent varnish layer and the top layer 26 or the second adhesive layer 25, which separating coating has lower adhesion to the transparent varnish layer than the cohesion in the transparent varnish layer. This additional varnish layer and the separating coating act as a security feature in the finished folding card to prevent changes to the personalisation, as detachment of the top layer results in a cohesion breakage in the transparent varnish layer, specifically in the regions where no separating coating is present. The cohesion breakage can be seen as a visible matting in the varnish layer. The regions which have the separating coating remain transparent.

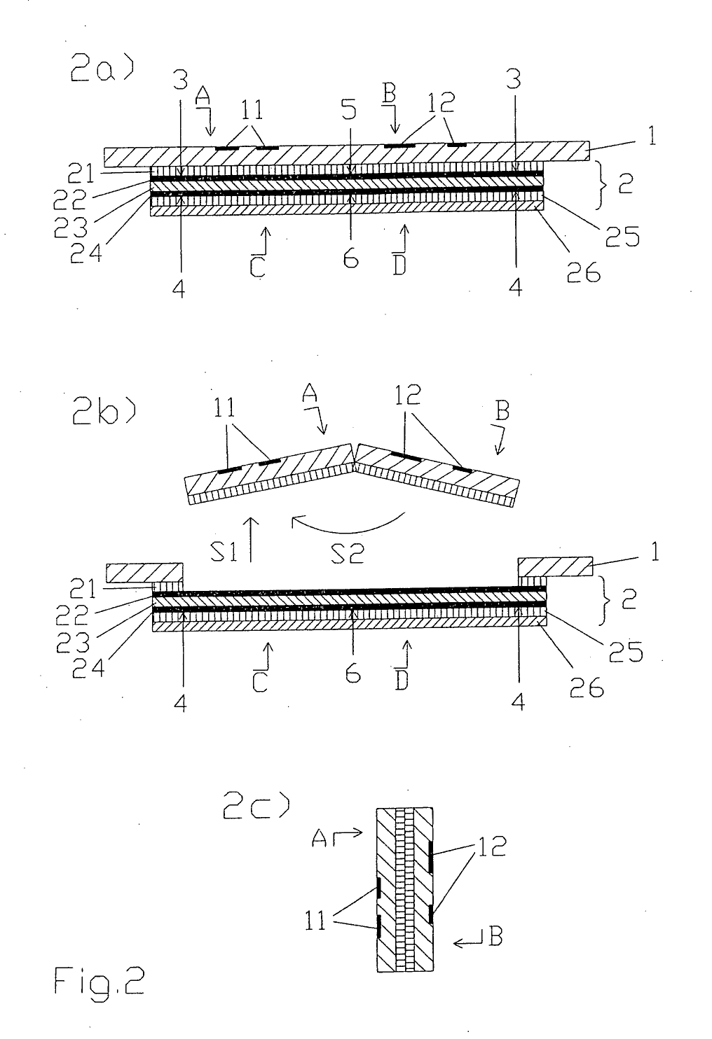

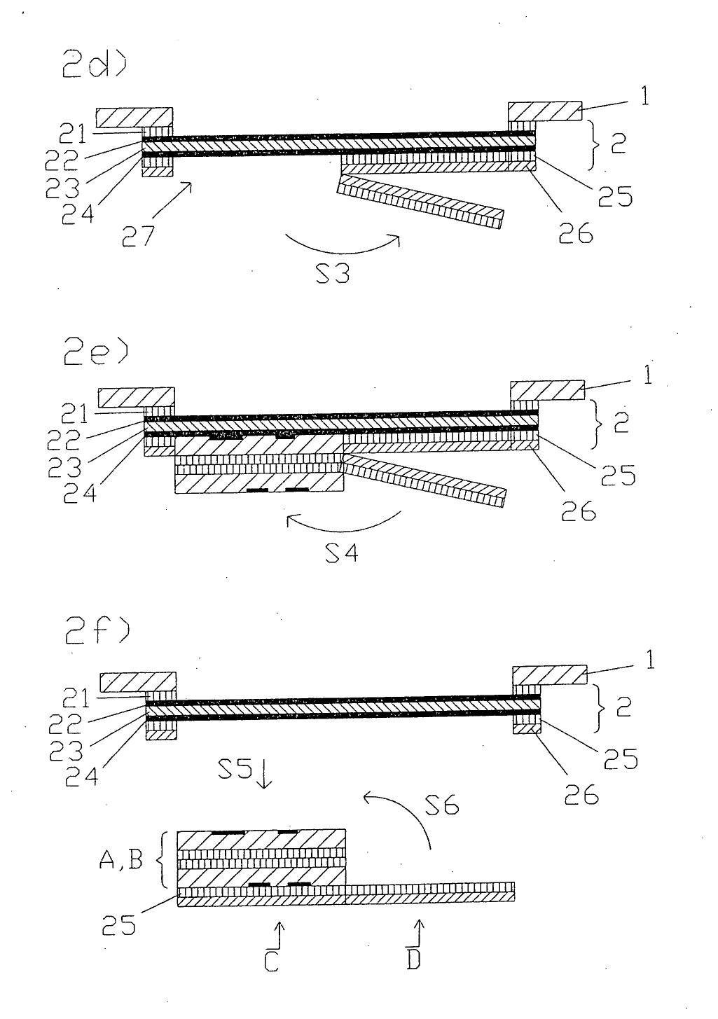

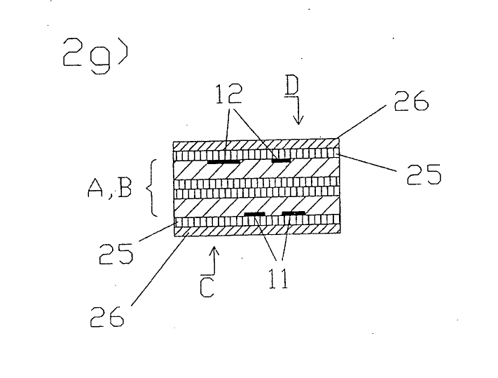

FIG. 2a) to g) show different phases in the production of a folding card using the form of FIG. 1. The figures each show a section along the section line I-I of FIG. 1.

FIG. 2a) shows the form of FIG. 1 in section. The substrate 1 is provided with the personalisation 11 in the region of the core part A and with the personalisation 12 in the region of the core part B.

In FIG. 2b), the two core parts A, B have been removed from the form S1, the adhesive layer 21 being detached from the dividing layer 22, which remains in the form. The two core parts A, B comprise a part of the flat substrate 1 with the personalisations 11, 12 and a part of the adhesive layer 21. The two core parts A, B are then folded up along the fold line with the perforation punch 5 S2.

FIG. 2c) shows the folded up core parts A, B. The two core parts A, B are adhesively bonded to each other in a coextensive manner with the first adhesive layer 21. The personalisations 11, 12 are situated on the outwardly facing surfaces.

FIG. 2d) shows the form after detaching the first covering part C from the form containing the covering parts C, D. The covering parts C, D are folded along the fold line with the perforation punch 6 S3, the second covering part D remaining at least partially connected to the form. When the first covering part C is detached, the second adhesive layer 25 is separated from the dividing layer 24. The detachment of the first covering part C produces a depression 27 on the rear of the form which is not sticky and in which the previously folded core parts A, B can be inserted, as shown in FIG. 2e). The core parts A, B fit exactly into the depression, because they are coextensive with the covering parts C, D.

After the previously folded up core parts A, B have been placed into the depression 27 in the form, the first covering part C is folded up again S4 and adhesively bonded to the personalised surface of the upper core part in the depression in a coextensive manner with the second adhesive layer 25.

The core parts A, B which are plasticised on one side in this manner by the transparent foil layer of the first covering part C are removed from the form together with the covering parts C, D S5, as shown in FIG. 20. The two covering parts C, D are then folded up along the fold line with the perforation punch 6 S6. The second covering part D is adhesively bonded in a coextensive manner to the personalised surface of the previously lower core part in the depression with the second adhesive layer 25 in order to obtain the finished folding card.

The finished folding card, as shown in FIG. 2g), is provided on both sides with the personalisations 11, 12, which are situated on the outwardly facing surfaces of the two core parts A, B. The outwardly facing surfaces of the core parts A, B are plasticised by the top layer 26 of the covering parts C, D.

It should be noted that the dimensions in the different figures, in particular the thicknesses of the different layers, are not to scale and only serve for illustration.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

We claim:

1. A form having a form front and form rear, said form including an integrated folding card, the integrated folding card comprising a flat substrate with a flat substrate rear, the integral folding card further comprising a multi-layer material, said multi-layer material being adhesively bonded to at least one part-region of the flat substrate rear with a first adhesive layer,
wherein the multi-layer material comprises, as viewed from the substrate:
the first adhesive layer,
a first dividing layer,
a carrier layer,
a second dividing layer,
a second adhesive layer, and
an at least partially transparent top layer,
wherein the folding card comprises two core parts and two covering parts,
wherein the form, in the region of the multi-layer material, has a first punch made from the front, the first punch forming which forms the two core parts, and
wherein the form, in the region of the multi-layer material, has a second punch made from the form rear no greater than the carrier layer the second punch forming the two covering parts,
wherein
the two core parts are arranged in a connected manner adjacently to each other in the same plane in the form,
the core parts and the covering parts are coextensive, and
the first punch is made no greater than the carrier layer to prevent penetration of the carrier layer.

2. The form according to claim 1, wherein the two covering parts are arranged in a connected manner adjacently to each other in the same plane in the form.

3. The form according to claim 1, wherein folding a first perforation punch or first stamp made along a fold line is provided for folding up the connected core parts in an easier manner than with just the fold line.

4. The form according to claim 1, wherein by a second perforation punch or second stamp made along a fold line is provided for folding up the connected covering parts in an easier manner.

5. The form according to claim 1, wherein the first punch and second punch lie essentially one above the other in the form.

6. The form according to claim 1, wherein the substrate has a part comprising the core parts, and wherein a part of the first adhesive layer can be removed from the form by detaching the part of first adhesive layer from the first dividing layer to remove the core parts.

7. The form according to claim 1, wherein the top layer has a part comprising the covering parts, wherein a part of the second adhesive layer can be removed from the form by detaching the part of the second adhesive layer from the second dividing layer to remove the covering parts.

8. The form according to claim 1, wherein the substrate is a paper layer with a thickness of 70 to 250 μm.

9. The form according to claim 1, wherein the carrier layer is a layer selected from the group consisting of a foil layer and a paper layer with a thickness of 23 to 60 μm.

10. The form according to claim 1, wherein the top layer is a highly transparent polyester foil with a thickness of 23 to 200 μm.

11. A method for producing a personalised folding card which is plasticised on both sides and comprises two core parts and two covering parts;
wherein, in the finished folding card, the two core parts comprising a substrate and a first adhesive layer are adhesively bonded in a coextensive manner to each other with the first adhesive layer, and at least one of the two outwardly facing surfaces of the substrate is personalised, and wherein the two covering parts comprising a top layer and a second adhesive layer are adhesively bonded in a coextensive manner to the outwardly facing surfaces of the two core parts with the second adhesive layer;
and wherein at least one form in which the two core parts and the two covering parts can each be removed and are integrated in a connected manner along a fold line, wherein said method comprises the following steps:
personalizing at least one surface of the substrate of the two core parts in the form containing the core parts;
removing the two core parts from the form containing the core parts;
folding up the two core parts along the fold line and adhesively bonding the two core parts to each other of the first adhesive layers;
detaching a first covering part of the two covering parts from the form containing the covering parts in such a manner that the second covering part connected to the first covering part remains at least partially connected to the form to form a depression;
inserting the core parts which are adhesively bonded to each other into the depression produced by the detachment of the first covering part;
adhesively bonding the first, detached covering part to the upper core part of the two core parts in the depression;
removing the core parts plasticised by the first covering part on one side in this manner from the depression together with the second covering part from the form containing the two covering parts; and
adhesively bonding the second covering part to the previously lower core part of the two core parts in the depression by folding together the two covering parts along the fold line.

12. The method according to claim 11 using a form according to claim 1, wherein steps a) and b) are carried out on the front of the form and steps d) to g) are carried out on the rear of the form.

13. The form according to claim 8, wherein the substrate is a paper layer with a thickness of 100 to 160 μm.

14. The form according to claim 9, wherein the carrier layer has a thickness of 23 to 36 μm for a foil layer or 50 to 60 μm for a paper layer.

15. The form according to claim 10, wherein the top layer is a highly transparent polyester foil with a thickness of 100 μm.
